(19) United States
(12) Patent Application Publication
(10) Pub. No.: US 2010/0172599 A1
(43) Pub. Date: Jul. 8, 2010

(54) IMAGE SIGNAL SCALER AND IMAGE SIGNAL PROCESSOR INCLUDING THE SAME

(76) Inventor: Ho-youn Choi, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/619,822

(22) Filed: Jan. 4, 2007

(30) Foreign Application Priority Data
Jan. 10, 2006 (KR) 10-2006-0002676

(51) Int. Cl. G06K 9/32

(52) U.S. Cl. 382/298; 382/299

(57) ABSTRACT

An image signal scaler and an image signal processor including the image signal scaler in which the image signal scaler includes a vertical scaler controlling a vertical image size of an input image signal, a horizontal scaler controlling a horizontal image size of the input image signal, an input/output controller controlling the vertical scaler and the horizontal scaler to transmit/receive an image signal to/from a memory, a read buffer reading an image signal stored in the memory through the input/output controller, a first multiplexer controlling a route of the input image signal, and a second multiplexer receiving an image signal from the vertical scaler, the horizontal scaler or the read buffer and outputting an output image signal. The vertical scaler or the horizontal scaler reduces the vertical image size or the horizontal image size of the input image signal and stores the input image signal in the memory through the input/output controller when the vertical image size or the horizontal image size of the input image signal is larger than the vertical image size or the horizontal image size of the output image signal.

### CROSS-REFERENCE IC) RELATED PATENT APPLICATION

This application claims the benefit of Korean Patent Application No. 10-2006-0002676, filed on Jan. 10, 2006, in the Korean Intellectual Property Office, the disclosure of which is incorporated herein in its entirety by reference.

### BACKGROUND OF THE INVENTION

1. Technical Field

The present disclosure relates to an image signal scaler and a processor including the same and, more particularly, to an image signal scaler capable of carrying out a scaling operation on an image signal without requiring a large memory bandwidth and an image signal processor including the same.

2. Discussion of Related Art

An image signal captured by a video camera or a camcorder is transmitted to a display device, such as a digital TV, via an image signal processor. The image signal processor removes noise from the image signal input thereto, deinterlaces the image signal when the image signal is an interlaced image signal, or scales the image signal.

FIG. 1 is a block diagram of a conventional image signal processor. The image signal processor includes a memory 110, a bus 120, a plurality of interface units IF1, IF2, IF3 and IF4, an input unit 130, a noise removal unit 140, a deinterlacing unit 150, and a scaler 160. The scaler 160 includes a vertical scaler 161 and a horizontal scaler 162.

The image signal processor receives an input image signal Sx, processes the received input image signal Sx and outputs an output image signal Sy. The input image signal Sx passes through the input unit 130, the interface units IF1 and the bus 120 and then is stored in the memory 110. The input image signal Sx stored in the memory is transferred to the noise removal unit 140 and noise is removed from the input image signal Sx by the noise removal unit 140. When the input image signal Sx is an interlaced image signal, the input image signal Sx from which noise has been removed, which is stored in the memory 110, is sent to the deinterlacing unit 150 to be deinterlaced. The image signal Sx that has been deinterlaced and stored in the memory 110 is transferred to the scaler 160 via the bus 120 and the interface unit IF4. The scaler 160 scales a vertical image size and a horizontal image size of the input image signal Sx and outputs the scaled image signal as the output image signal Sy. The output image signal Sy is transmitted to a video processing block (not shown) that performs graphic processing, for example.

The input image signal Sx is stored in the form of a plurality of lines of image data in the memory 110. When the size of an image corresponding to the input image signal Sx (referred to as the image size of the input image signal) is larger than the size of an image corresponding to the output image signal Sy (referred to as the image size of the output image signal), the scaler 160 should simultaneously read image data of more than two lines from the memory 110 for one-time memory access. For example, when the image size of the input image signal Sx is twice the image size of the output image signal Sy, that is, when it is required that the image size of the input image signal Sx be reduced by half to be output as the output image signal Sy, the scaler 160 should simultaneously read image data of two lines for each one-time memory access. The image data of two lines read by the scaler 160 for one-time memory access corresponds to image data of one line of the output image signal Sy.

As the quantity of data read by the sealer 160 for one-time memory access increases, higher memory bandwidth is required. A demand for a high memory bandwidth becomes a problem in image signal processing, because the amount of memory bandwidth is limited.

### SUMMARY OF THE INVENTION

Exemplary embodiments of the present invention provide an image signal scaler and an image signal processor that do not require a high memory bandwidth.

Exemplary embodiments of the present invention also provide an image signal scaler and an image signal processor for preventing overtaking between an operation of writing an image signal in a memory and an operation of reading the image signal from the memory.

According to an exemplary embodiment of the present invention, there is provided an image signal scaler comprising a vertical scaler controlling a vertical image size of an input image signal; a horizontal scaler controlling a horizontal image size of the input image signal; an input/output controller controlling the vertical scaler and the horizontal scaler to transmit/receive an image signal to/from a memory; a read buffer reading an image signal stored in the memory through the input/output controller; a first multiplexer controlling a route of the input image signal; and a second multiplexer receiving an image signal from the vertical scaler, the horizontal scaler or the read buffer and outputting an output image signal. The vertical scaler or the horizontal scaler reduces the vertical image size or the horizontal image size of the input image signal and stores the input image signal in the memory through the input/output controller when the vertical image size or the horizontal image size of the input image signal is larger than the vertical image size or the horizontal image size of the output image signal.

When the vertical scaler or the read buffer reads an image signal stored in the form of image data of a plurality of lines in the memory through the input/output controller, the vertical scaler or the read buffer reads only image data of one of the plurality of lines from the memory for one-time memory access.

The input/output controller prevents overtaking between an operation of writing an image signal to the memory and an operation of reading the image signal from the memory.

The input/output controller includes a write controller controlling the operation of writing an image signal to the memory, a read controller controlling the operation of reading the image signal from the memory, and an input/output synchronization controller preventing overtaking.

When the vertical image size of the input image signal is smaller than the vertical image size of the output image signal and the horizontal image size of the input image signal is larger than the horizontal image size of the output image signal, the horizontal image size of the input image signal is reduced while the input image signal passes through the first multiplexer, the horizontal scaler and the input/output controller and then the reduced input image signal is stored in the memory.

The image signal scaler may further comprise a standard definition (SD) converter converting a high definition (HD) image signal into an SD image signal in response to a conversion control signal when the output image signal is an HD image signal, and an output multiplexer outputting one of the HO image signal and the SD image signal in response to an output control signal.

According to an exemplar embodiment of the present invention, there is provided an image signal processor comprising: an input unit receiving an input image signal; a noise removal unit removing noise from the input image signal; a vertical scaler controlling a vertical image size of the input image signal; a horizontal scaler controlling a horizontal image size of the input image signal; an input/output controller controlling the vertical scaler and the horizontal scaler to transmit/receive an image signal to/from a memory and preventing overtaking between an operation of writing an image signal to the memory and an operation of reading the image signal from the memory; a read buffer reading an image signal stored in the memory through the input/output controller; an input multiplexer and a first multiplexer controlling a route of the input image signal among the input unit, the noise removal unit, the vertical scaler, and the horizontal scaler; and a second multiplexer receiving an image signal from the vertical scaler, the horizontal scaler or the read buffer and outputting an output image signal. The vertical image size or the horizontal image size of the input image signal is reduced by the vertical scaler or the horizontal scaler and then the input image signal is stored in the memory.

The image signal processor further comprises a deinterlacing unit deinterlacing an interlaced image signal. The deinterlacing unit deinterlaces an image signal received from the memory when the image signal is an interlaced signal and stores the deinterlaced image signal in the memory.

According to an exemplary embodiment of the present invention, an image signal can be scaled without requiring a high memory bandwidth. Furthermore, overtaking between an operation of writing an image signal in a memory and an operation of reading the image signal from the memory is not generated. Moreover, an input image signal is processed such that an HD image signal and an SD image signal can be selectively output.

### BRIEF DESCRIPTION OF THE DRAWINGS

Exemplary embodiments of the present invention will be understood in more detail from the following descriptions taken in conjunction with the attached drawings in which:

FIG. 1 is a block diagram of a conventional image signal processor;

FIG. 2 is a block diagram of an image signal scaler according to an exemplary embodiment of the present invention;

FIGS. 3A, 3B, 3C, and 3D illustrate input image signal processing routes in the image signal scaler of FIG. 2; and

FIG. 4 is a block diagram of an image signal processor according to an exemplary embodiment of the present invention.

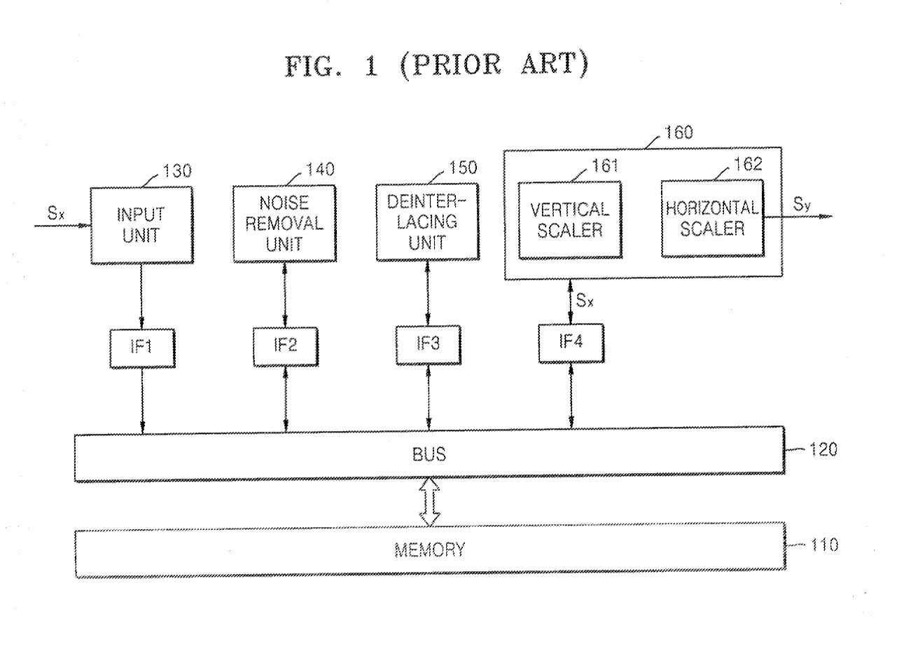

### DETAILED DESCRIPTION OF EXEMPLARY EMBODIMENTS

Exemplary embodiments of the present invention will now be described more fully with reference to the accompanying, drawings, in which the exemplary embodiments of the invention are shown. The invention may, however, be embodied in many different forms and should not be construed as being limited to the exemplary embodiments set forth herein; rather, these exemplary embodiments are provided so that this disclosure will be thorough and complete and will fully convey the concept of the invention to those skilled in the art. Throughout the drawings, like reference numerals refer to like elements.

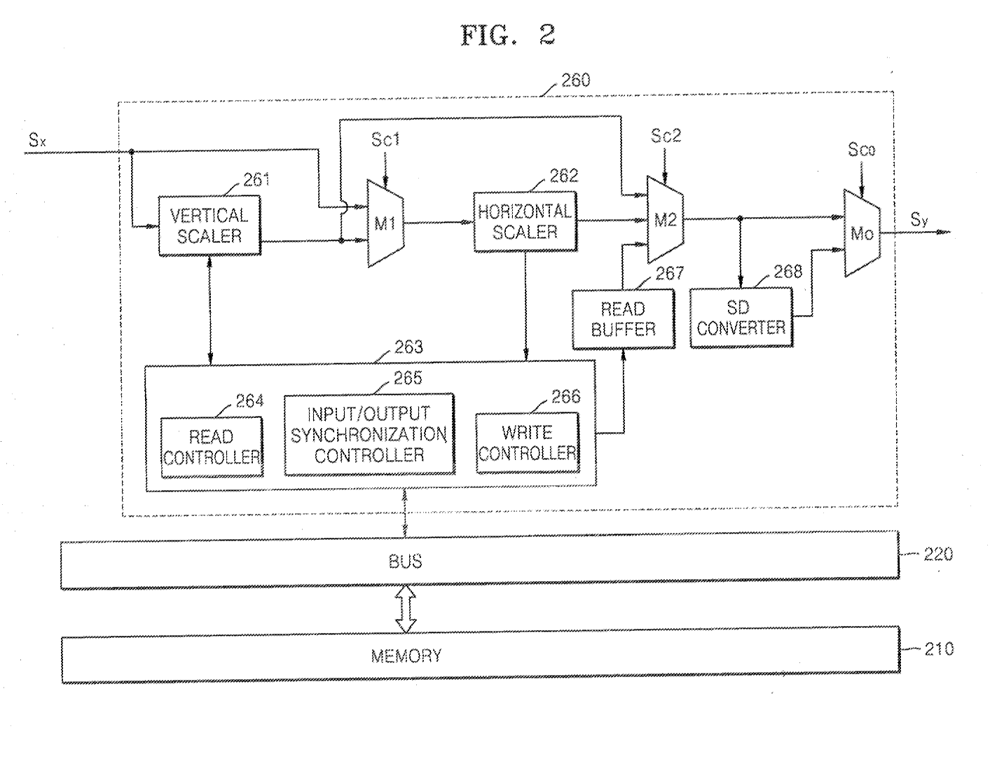

FIG. 2 is a block diagram of an image signal scaler 260 according to an exemplary embodiment of the present invention. FIG. 2 illustrates a memory 210, a bus 220 and the image signal scaler 260, The image signal scaler 260 includes a vertical scaler 261, a horizontal scaler 262, an input/output controller 263, a read buffer 267, a first multiplexer M1 operated in response to a first control signal Sc1, a second multiplexer M2 operated in response to a second control signal Sc2, a standard definition (SD) converter 268, and an output multiplexer Mo operated in response to an output control signal Sco. The input/output controller 263 includes a read controller 264, an input/output synchronization controller 265, and a write controller 266.

The vertical scaler 261 controls a vertical image size of an input image signal Sx. That is, the vertical scaler 261 reduces, maintains or magnifies the vertical image size of the input image signal Sx input thereto.

The horizontal scaler 262 controls a horizontal image size of the input image signal Sx. That is, the vertical scaler 261 reduces, maintains or magnifies the horizontal image size of the input image signal Sx input thereto.

The input/output controller 263 controls the vertical scaler 261 and the horizontal scaler 262 to transmit/receive an in signal to/from the memory 210. That is the input/output controller 263 controls an operation of writing an image signal in the memory 210 and an operation of reading the image signal from the memory 210. The read controller 264, the input/output synchronization controller 265 and the write controller 266 will be explained in more detail hereinafter.

The read buffer 267 reads the image signal stored in the memory 210 through the input/output controller 263 and outputs the read image signal to the second multiplexer M2.

The first multiplexer M1 controls a route of the input image signal Sx in response to the first control signal Sc1. The second multiplexer M2 receives an image signal from the vertical scaler 261, the horizontal scaler 262 or the read buffer 267 and outputs an output image signal Sy in response to the second control signal Sc2.

The SD converter 268 converts the output image signal Sy output from the second multiplexer M2 into a standard definition (SD) image signal in response to a conversion control signal (not shown) when the output image signal Sy is a high definition (HD) image signal. The image signal scaler 260 according to an exemplary embodiment of the present invention can output SD image signals as well as HD image signals using the SD converter 268. In this way, the image signal scaler 260 can be efficiently used.

The output multiplexer Mo selectively outputs an HD output image signal and an SD output image signal. That is, the output multiplexer Mo outputs one of the HD image signal output from the second multiplexer M2 and the SD image signal output from the SD converter 268 as the output image signal Sy in response to the output control signal Sco.

The image signal scaler 260 having the aforementioned components scales (reduces, maintains or magnifies) the vertical image size or the horizontal image signal of the input image signal Sx and outputs the scaled image signal as the output image signal Sy. More specifically, the image signal scaler 260 performs an operation of reducing the image size of the input image signal Sx input thereto and storing the image signal having a reduced image size and an operation of maintaining or magnifying the image size of the image signal stored in the memory and outputting the image signal as the output image signal Sy.

The vertical image size and the horizontal image size of the input image signal Sx and the vertical image size and the horizontal image size of the output image signal Sy determine whether the vertical scaler 261 or the horizontal scaler 262 reduces, maintains or magnifies the vertical image size or the horizontal image size of the input image signal Sx.

When the vertical or horizontal image size of the input image signal Sx is larger than the vertical or horizontal image size of the output image signal Sy, the vertical or horizontal scaler 261 or 262 reduces the vertical or horizontal image size of the input image signal Sx to correspond to the vertical or horizontal image size of the output image signal Sy. The input image signal Sx having a reduced vertical or horizontal image size is stored in the memory 210 through the input/output controller 263.

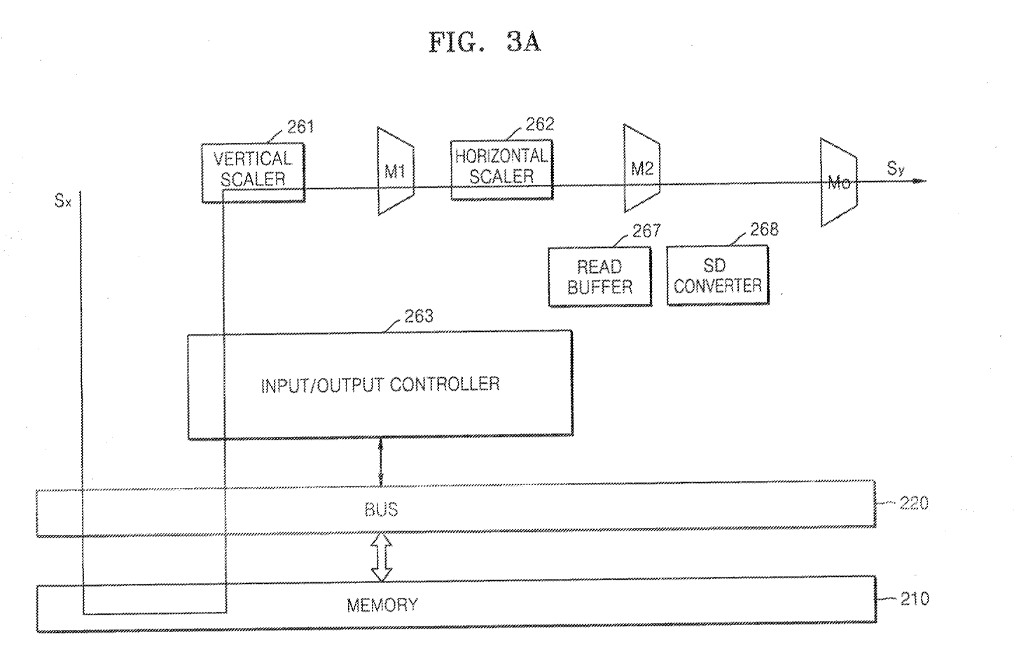

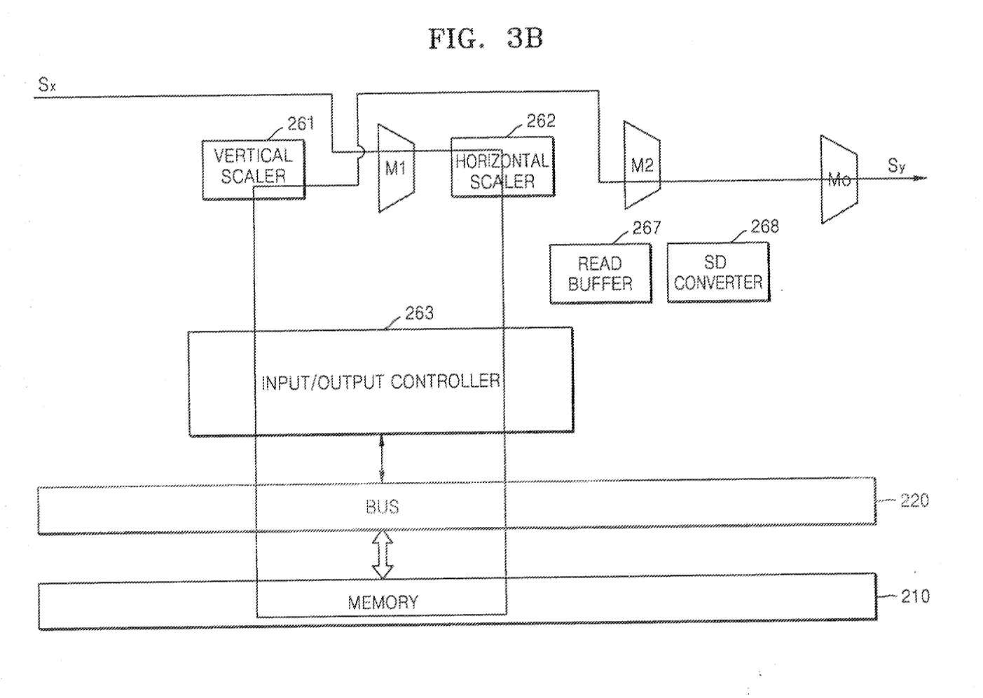

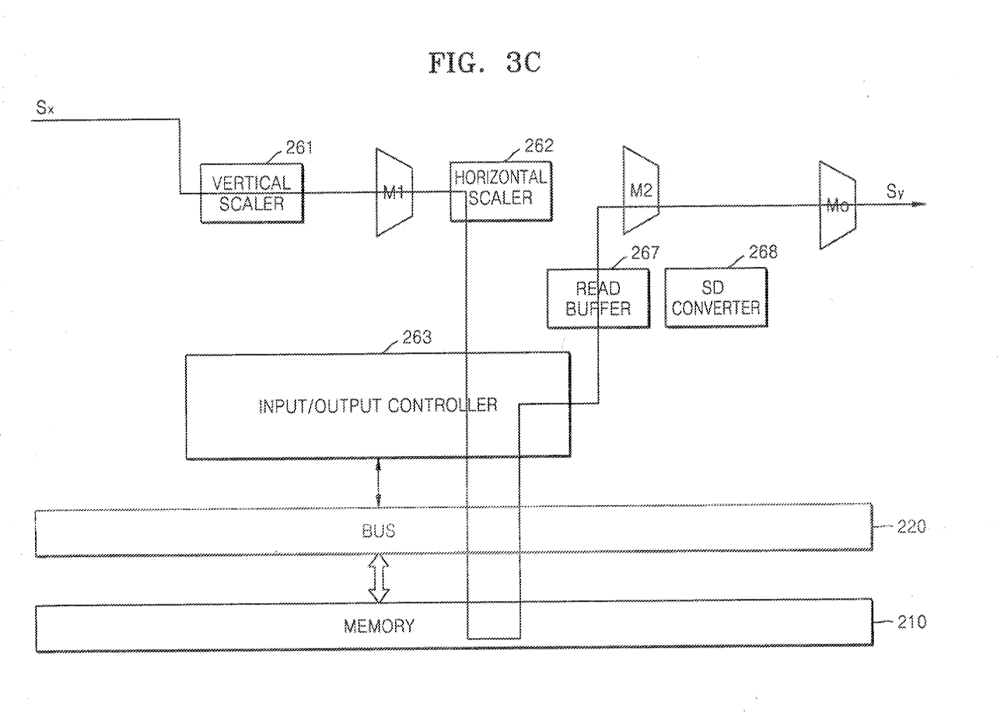

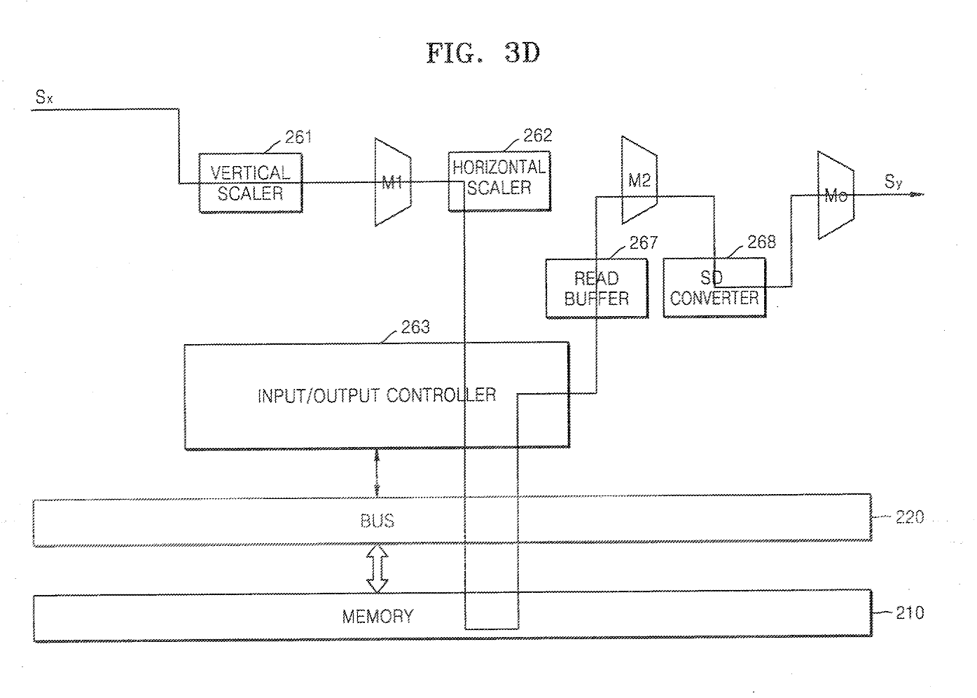

When the vertical and horizontal image sizes of the input image signal Sx are smaller than or equal to the vertical and horizontal image sizes of the output image signal Sy, the input image signal Sx is directly stored in the memory 210 without passing through the vertical scaler 261 or the horizontal scaler 262. A route through which the input image signal Sx is transmitted when the vertical and horizontal image sizes of the input image signal Sx are smaller than or equal to the vertical and horizontal image sizes of the output image signal Sy will be explained in detail with reference to FIG. 3A.

The input image signal Sx is stored in the form of a plurality of lines of image data in the memory 210. The image signal scaler 260 reads the image signal stored in the memory 210, maintains or magnifies the image size of the read image signal and outputs the image signal having a maintained or magnified image size as the output image signal Sy.

When the image signal scaler 260 maintains the image size of the image signal stored in the memory 210 and outputs it as the output image signal Sy, the image signal scaler 260 reads only image data of one line from the memory 210 for one-time memory access. The image data of one line read from the memory 210 corresponds to image data of one line of the output image signal Sy.

When the image signal scaler 260 magnifies the image size of the image signal stored in the memory 210 (magnifies it twice, for example) and outputs it as the output image signal Sy, the image signal scaler 260 reads only image data of one line from the memory 210 for one-time memory access and reads the image data of the same line from the memory 210 for another memory access. The image data of the same line read from the memory 210 twice corresponds to image data of two lines of the output image signal Sy. Consequently, the image size of the input image signal Sx is magnified twice to be output as the output image signal Sy.

The image signal scaler 260 is not required to reduce the image size of the image signal stored in the memory 210 to output the output image signal Sy. However, if the image signal scaler 260 reduces the image signal of the image signal stored in the memory 210 (reduces it by half, for example) and outputs the image signal as the output image signal Sy, the image signal scaler 260 should simultaneously read image data of two lines from the memory 210 for one-time memory access. The image data of two lines simultaneously read from the memory 210 for one-time memory access corresponds to an image signal of one line of the output image signal Sy.

When the image signal scaler 260 simultaneously reads image data of more than two lines from the memory 210 for one-time memory access, a high memory bandwidth is required. When such a high memory bandwidth is not supported, however, the operation of scaling the image signal cannot be smoothly performed.

To solve the problem of limitations on the memory bandwidth, the image signal scaler 260 according to an exemplary embodiment of the present invention reduces the vertical or horizontal image size of the input image signal Sx to correspond to the vertical or horizontal image size of the output image signal Sy in advance and stores the image signal having the reduced vertical or horizontal in size in the memory when the vertical or horizontal image size of the input image signal Sx is larger than the vertical or horizontal image size of the output image signal Sy. Accordingly, the image signal scaler 260 can read only image data of one line from the memory 210 for one-time memory access when reading the image signal having a reduced vertical or horizontal image size stored in the memory 210 to output the output image signal Sy.

Consequently, the image signal scaler 260 according to an exemplary embodiment of the present invention reads only image data of one line from the memory 210 for one-time memory access in any case when the image signal scaler 260 reads the image signal stored in the memory 210 to output the output image signal Sy. In other words, when the image signal stored in the memory 210 is composed of a plurality of lines of image data, the image signal scaler 260 reads only image data of one line from the memory 210 for one-time memory access and does not simultaneously read image data of more than two lines from the memory 210 for one-time memory access. Accordingly, image signal processing can be carried out without requiring a high memory bandwidth.

The input/output controller 263 controls the vertical scaler 261 and the horizontal scaler 262 to transmit/receive the image signal to/from the memory 210. The write controller 266 controls the operation of writing the image signal in the memory 210 and the read controller 264 controls the operation of reading the image signal from the memory 210.

The input/output controller 263 includes the input/output synchronization controller 265 in order to prevent overtaking between the operation of writing the image signal in the memory 210 and the operation of reading the image signal from the memory 210. When an input clock signal used when the input image signal Sx is input to the memory 210 is different from an output clock signal used when the image signal stored in the memory 210 is read, overtaking may occur between the operation of inputting the image signal to the memory 210 and the operation of reading the image signal from the memory 210. That is, overtaking can occur when an input frame rate is different from an output frame rate. The overtaking brings about a poor image in which an old frame and a new frame are mixed.

The input/output synchronization controller 265 controls the write controller 266 and the read controller 264 to prevent overtaking between the operation of writing the image signal in the memory 210 and the operation of reading the image signal from the memory 210. For example, the input/output synchronization controller 265 repeats or omits the operation of writing the image signal to the memory 210 or the operation of reading the image signal from the memory 210 for a certain frame to prevent the overtaking between the two operations.

FIGS. 3A, 3B, 3C, and 3D illustrate input image signal processing routes in the image signal scaler of FIG. 2.

When the vertical and horizontal image sizes of the input image signal Sx are smaller than or equal to the vertical and horizontal image sizes of the output image signal Sy, the input image signal Sx is directly transferred to the memory 210 and stored therein, as illustrated in FIG. 3A. When the vertical or horizontal image size of the input image signal Sx is larger than the vertical or horizontal image size of the output image signal Sy, the input image signal Sx is transferred to the vertical scaler 261 or the horizontal scaler 262, as illustrated in FIGS. 3B, 3C, and 3D.

FIG. 3A illustrates a route of the input image signal Sx when the vertical and horizontal image sizes of the input image signal Sx are smaller than or equal to the vertical and horizontal image sizes of the output image signal Sy. Referring to FIG. 3A, the vertical and horizontal image sizes of the input image signal Sx directly transferred to the memory 210 and stored therein are magnified to correspond to the vertical and horizontal image sizes of the output image signal Sy while the input image signal Sx passes through the input/output controller 263, the vertical scaler 261, the first multiplexer M1 and the horizontal scaler 262. The image signal having magnified vertical and horizontal image sizes is output as the output image signal Sy via the second multiplexer M2 and the output multiplexer Mo.

FIG. 3B illustrates a route of the input image signal Sx when the vertical image size of the input image signal Sx is smaller than the vertical image size of the output image signal Sy and the horizontal image size of the input image signal Sx is larger than the horizontal image size of the output image signal Sy. Referring to FIG. 3B, the horizontal image size of the input image signal Sx is reduced while the input image signal Sx passes through the first multiplexer M1, the horizontal scaler 262 and the input/output controller 263 and then the input image signal Sx is stored in the memory 210. The vertical image size of the image signal having a reduced horizontal image size is magnified to correspond to the vertical image size of the output image signal Sy while the image signal passes through the input/output controller 263 and the vertical scaler 261. The image signal having a magnified vertical image size is output as the output image signal Sy via the second multiplexer M2 and the output multiplexer Mo.

FIG. 3C illustrates a route of the input image signal Sx when the vertical and horizontal image sizes of the input image signal Sx are larger than the vertical and horizontal image sizes of the output image signal Sy. Referring to FIG. 3C, the vertical and horizontal image sizes of the input image signal Sx are reduced to correspond to the vertical and horizontal image sizes of the output image signal Sy while the input image signal Sx passes through the vertical scaler 261, the first multiplexer M1, the horizontal scaler 262 and the input/output controller 263. The image signal having reduced vertical and horizontal image sizes, stored in the memory 210, is output as the output image signal Sy via the input/output controller 263, the read buffer 267, the second multiplexer M2 and the output multiplexer Mo.

FIG. 3D illustrates a route of the input image signal Sx when an HD image signal output from the second multiplexer M2 is converted into an SD image signal. Referring to FIG. 31), the input image signal Sx sequentially passes through the vertical scaler 261, the first multiplexer M1, the horizontal scaler 262, the input/output controller 263, the memory 210, the input/output controller 263, the read buffer 267 and the second multiplexer M2. When the image signal output from the second multiplexer M2 is an HD image signal and this HD image signal is required to be converted into an SD image signal, the HD image signal is input to the SD converter 268. The output multiplexer Mo outputs one of the RD image signal output from the to second multiplexer M2 and the SD image signal output from the SD converter 268 as the output image signal Sy in response to the output control signal (Sco in FIG. 2).

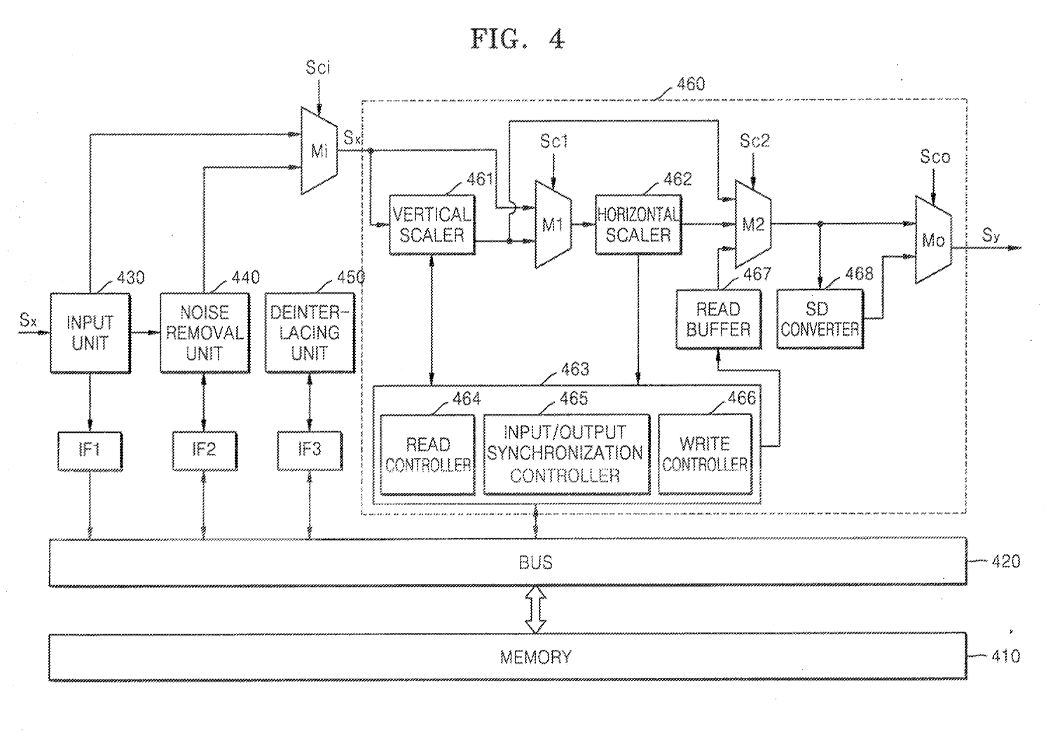

FIG. 4 is a block diagram of an image signal processor according to an exemplary embodiment of the present invention. Referring to FIG. 4, the image signal processor includes a memory 410, a bus 420, a plurality of interface units IF1, IF2 and IF3, an input unit 430, a noise removal unit 440, a deinterlacing unit 450, an input multiplexer Mi operated in response to an input control signal Sci, and a scaler 460.

The scaler 460 corresponds to the image signal scaler 260 of FIG. 2. That is, the scaler 460 includes a vertical scaler 461, a horizontal scaler 462, an input/output controller 463, a read buffer 467, a first multiplexer M1 operated in response to a first control signal Sc1, a second multiplexer operated in response to a second control signal Sc2, an SD converter 468, and an output multiplexer Mo operated in response to an output control signal Sco. The input/output controller 463 includes a read controller 464, an input/output synchronization controller 465 and a write controller 466.

As described above, a vertical or horizontal image size of an input image signal Sx input to the scaler 460 can be reduced by the vertical or horizontal scaler 461 or 462 to correspond to a vertical or horizontal image size of an output image signal Sy and then the input image signal Sx can be stored in the memory 410. Accordingly, when the vertical scaler 461 or the read buffer 467 reads the image signal stored in the form of a plurality of lines of image data in the memory 410 through the input/output controller 463, the vertical scaler 461 or the read buffer 467 reads only image data of one line from the memory 410 for one-time memory access and does not simultaneously read image signal of more than two lines from the memory 410 for one-time memory access.

The input/output controller 463 controls the vertical scaler 461 and the horizontal scaler 462 to transmit/receive an image signal to/from the memory 410 and prevents overtaking between an operation of writing the image signal in the memory 410 and an operation of reading the image signal from the memory 410.

The input image signal Sx output from the input unit 430 is transmitted to the memory 410 and stored therein or transmitted to the noise removal unit 440. Otherwise, the input image signal Sx is transmitted to the input multiplexer M1. The noise removal unit 440 removes noise from the input image signal Sx input thereto and transmits the input, image signal Sx from which noise has been removed to the input multiplexer Mi.

As illustrated in FIG. 4, the input image signal Sx can be transmitted from the input unit 430 to the input multiplexer Mi via the noise removal unit 440 or directly transmitted from the input unit 430 to the input multiplexer Mi without passing through the noise removal unit 440. That is, the noise removal process can be omitted when the input image signal Sx does not require noise removal.

The deinterlacing unit 450 reads the input image signal Sx stored in the memory 410 and deinterlaces the read image signal Sx when the input image signal Sx is an interlaced image signal. The deinterlacing unit 450 stores the deinterlaced image signal in the memory 410.

The input multiplexer Mi transmits the input image signal Sx received from the input unit 430 or the noise removal unit 440 to the vertical scaler 461 or transmits the input image signal Sx to the horizontal scaler 462 via the first multiplexer M1 in response to the input control signal Sci.

When the image signal output from the second multiplexer M2 is an RD image signal, the output multiplexer Mo outputs one of the HD image signal output from the second multiplexer M2 and an SD image signal output from the SD converter 468 as the output image signal Sy in response to the output control signal Sco.

Exemplary operation modes of the image signal processor of FIG. 4 will now be explained.

When the vertical or horizontal image size of the input image signal Sx is larger than the vertical or horizontal image size of the output image signal Sy, the input image signal Sx is transmitted from the input unit 430 or the noise removal unit 440 to the vertical sealer 461 or the horizontal scaler 462 via the input multiplexer Mi.

When the vertical and horizontal image sizes of the input image signal Sx are larger than the vertical and horizontal image sizes of the output image signal Sy, the vertical and horizontal image sizes of the input image signal Sx are reduced while the input image signal Sx passes through the vertical scaler 461, the first multiplexer M1, the horizontal scaler 462 and the input/output controller 463 and then the input image signal Sx is stored in the memory 410. The image signal having reduced vertical and horizontal image sizes, stored in the memory 410, is output as the output image signal Sy via the input/output controller 463, the read buffer 467, the second multiplexer M2 and the output multiplexer Mo.

When the vertical image size of the input image signal Sx is smaller than the vertical image size of the output image signal Sy and the horizontal image size of the input image signal Sx is larger than the horizontal image size of the output image signal Sy, the horizontal image size of the input image signal Sx is reduced while the input image signal Sx passes through the first multiplexer M1, the horizontal scaler 462 and the input/output controller 463, and then the input image signal Sx is stored in the memory 410. The vertical image size of the image signal having a reduced horizontal image size is magnified to correspond to the vertical image size of the output image signal Sy while the image signal passes through the input/output controller 463 and the vertical scaler 461. The image signal having a magnified vertical image size is output as the output image signal Sy via the second multiplexer M2 and the output multiplexer Mo.

When the vertical and horizontal image sizes of the input image signal Sx are smaller than the vertical and horizontal image sizes of the output image signal Sy, the input image signal Sx is directly transmitted from the input unit 430 or the noise removal unit 440 to the memory 410 and stored in the memory 410. The vertical and horizontal image sizes of the input image signal Sx directly input to the memory 210 and stored therein are magnified to correspond to the vertical and horizontal image sizes of the output image signal Sy while the input image signal Sx passes through the input/output controller 463, the vertical scaler 461, the first multiplexer M1 and the horizontal scaler 462. The image signal having magnified vertical and horizontal image sizes is output as the output image signal Sy via the second multiplexer M2 and the output multiplexer Mo.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image signal scaler comprising:
a vertical scaler controlling a vertical image size of an input image signal;
a horizontal scaler controlling a horizontal image size of the input image signal;
an input/output controller controlling the vertical scaler and the horizontal scaler to transmit/receive an image signal to/from a memory and preventing overtaking between an operation of writing an image signal to the memory and reading the image signal from the memory;
a read buffer storing an image signal read from the memory through the input/output controller;
a first multiplexer controlling a route of the input image signal; and
a second multiplexer receiving an image signal from the vertical scaler, the horizontal scaler or the read buffer and outputting an output image signal,
wherein the vertical scaler or the horizontal scaler reduces the vertical image size or the horizontal image size of the input image signal and stores the reduced input image signal in the memory through the input/output controller when the vertical image size or the horizontal image size of the input image signal is larger than the vertical image size or the horizontal image size of the output image signal.

2. The image signal scaler of claim 1, wherein, when the vertical scaler or the read buffer reads an image signal stored in the form of a plurality of lines of image data in the memory through the input/output controller, the vertical scaler or the read buffer reads only image data of one of the plurality of lines from the memory for one-time memory access.

3. (canceled)

4. The image signal scaler of claim 1, wherein the input/output controller comprises:
a write controller controlling the operation of writing an image signal to the memory;
a read controller controlling the operation of reading the image signal from the memory; and
an input/output synchronization controller preventing the overtaking.

5. The image signal scaler of claim 1, wherein, when the vertical image size and the horizontal image size of the input image signal are larger than the vertical image size and the horizontal image size of the output image signal, the vertical image size and the horizontal image size of the input image signal are reduced while the input image signal passes through the vertical scaler, the first multiplexer, the horizontal scaler and the input/output controller and then the reduced input image signal is stored in the memory.

6. The image signal scaler of claim 5, wherein the reduced input image signal, stored in the memory is output as the output image signal via the input/output controller, the read buffer and the second multiplexer.

7. The image signal scaler of claim 1, wherein, when the vertical image size of the input image signal is smaller than the vertical image size of the output image signal and the horizontal image size of the input image signal is larger than the horizontal image size of the output image signal, the horizontal image size of the input image signal is reduced while the input image signal passes through the first multiplexer, the horizontal scaler and the input/output controller and then the reduced input image signal is stored in the memory,

8. The image signal scaler of claim 7, wherein the vertical image size of the reduced input image signal is magnified to correspond to the vertical image size of the output image signal while the reduced input image signal passes through the input/output controller and the vertical scaler.

9. The image signal scaler of claim 8, wherein the image signal having a vertical image size magnified to correspond to the vertical image size of the output image signal is output as the output image signal via the second multiplexer.

10. The image signal scaler of claim 1, wherein the input image signal is input to the vertical scaler or the horizontal scaler when the vertical image size or the horizontal image size of the input image signal is larger than the vertical image size or the horizontal image size of the output image signal and the input image signal is directly input to the memory and stored therein when the vertical image size and the horizontal image size of the input image signal are smaller than the vertical image size and the horizontal image size of the output image signal.

11. The image signal scaler of claim 10, wherein the vertical image size and the horizontal image size of the input image signal directly input to the memory and stored therein are magnified to correspond to the vertical image size and the horizontal image size of the output image signal while the input image signal directly input to the memory and stored therein passes through the input/out controller, the vertical scaler, the first multiplexer and the horizontal scaler.

12. The image signal scaler of claim 11, wherein the image signal having vertical and horizontal image sizes magnified to correspond to the vertical and horizontal image sizes of the output image signal is output as the output image signal via the second multiplexer.

13. The image signal scaler of claim 1, further comprising a standard definition (SD) converter converting a high definition (HD) image signal into an SD image signal in response to a conversion control signal when the output image signal is an HD image signal.

14. The image signal scaler of claim 13, further comprising an output multiplexer outputting one of the HD image signal and the SD image signal in response to an output control signal.

15. An image signal processor comprising:
an input unit receiving an input image signal;
a noise removal unit removing noise from the input image signal;
a vertical scaler controlling a vertical image size of the input image signal;
a horizontal scaler controlling a horizontal image size of the input image signal;
an input/output controller controlling the vertical scaler and the horizontal scaler to transmit/receive an image signal to/from a memory and preventing overtaking between an operation of writing an image signal to the memory and an operation of reading the image signal from the memory;
a read buffer storing an image signal read from the memory through the input/output controller;
an input multiplexer and a first multiplexer controlling a route of the input image signal among the input unit, the noise removal unit, the vertical scaler and the horizontal scaler; and
a second multiplexer receiving an image signal from the vertical scaler, the horizontal scaler or the read buffer and outputting an output image signal,
wherein the vertical image size or the horizontal image size of the input image signal is reduced by the vertical scaler or the horizontal scaler and then the reduced input image signal is stored in the memory through the input/output controller when the vertical image size or the horizontal image size of the input image signal is larger than the vertical image size or the horizontal image size of the output image signal.

16. The image signal processor of claim 15, wherein, when the vertical scaler or the read buffer reads an image signal stored in the form of a plurality of lines of image data in the memory through the input/output controller, the vertical scaler or the read buffer reads only image data of one line from the memory for one-time memory access.

17. The image signal processor of claim 15, wherein the input image signal is transmitted from the input unit or the noise removal unit to the vertical scaler or the horizontal scaler via the input multiplexer when the vertical image size or the horizontal image size of the input image signal is larger the vertical image size or the horizontal image size of the output image signal.

18. The image signal processor of claim 17, wherein, when the vertical image size and the horizontal image size of the input image signal are larger than the vertical image size and the horizontal image size of the output image signal, the vertical image size and the horizontal image size of the input image signal are reduced while the input image signal passes through the vertical scaler, the first multiplexer, the horizontal scaler and the input/output controller and then the reduced input image signal is stored in the memory, and the reduced input image signal stored in the memory is output as the output image signal via the input/output controller, the read buffer and the second multiplexer.

19. The image signal processor of claim 17, wherein, when the vertical image size of the input image signal is smaller than the vertical image size of the output image signal and the horizontal image size of the input image signal is larger than the horizontal image size of the output image signal, the horizontal image size of the input image signal is reduced while the input image signal passes through the first multiplexer, the horizontal scaler and the input/output controller and then the reduced input image signal is stored in the memory, the vertical image size of the reduced input image signal is magnified to correspond to the vertical image size of the output image signal while the reduced input image signal passes through the input/output controller and the vertical scaler, and the image signal having a vertical image size magnified to correspond to the vertical image size of the output image signal is output as the output image signal via the second multiplexer.

20. The image signal processor of claim 15, wherein the input image signal is directly input to the memory and stored therein when the vertical image size and the horizontal image size of the input image signal are smaller than the vertical image size and the horizontal image size of the output image signal.

21. The image signal processor of claim 20, wherein the vertical image size and the horizontal image size of the input image signal directly input to the memory and stored therein are magnified to correspond to the vertical image size and the horizontal image size of the output image signal while the input image signal directly input to the memory and stored therein passes through the input/out controller, the vertical scaler, the first multiplexer and the horizontal scaler, and the image signal having vertical and horizontal image sizes magnified to correspond to the vertical and horizontal image sizes of the output image signal is output as the output image signal via the second multiplexer.

22. The image signal processor of claim 15, wherein the input/output controller comprises:
a write controller controlling the operation of writing an image signal to the memory;
a read controller controlling the operation of reading the image signal from the memory; and
an input/output synchronization controller preventing the overtaking.

23. The image signal processor of claim 15, further comprising a deinterlacing unit deinterlacing an interlaced image signal, the deinterlacing unit deinterlacing an image signal received from the memory when the image signal is an interlaced signal and storing the deinterlaced image signal in the memory.

24. The image signal processor of claim 15, further comprising:
a standard definition (SD) converter converting a high definition (HD) image signal into an SD image signal in response to a conversion control signal when the output image signal is an HD image signal; and
an output multiplexer outputting one of the HD image signal and the SD image signal in response to an output control signal.
